(19) United States
(12) Patent Application Publication
(10) Pub. No.: US 2009/0204681 A1
(43) Pub. Date: Aug. 13, 2009

(54) METHOD, SERVER AND CLIENT FOR PROCESSING EMAILS

(75) Inventor: Qian Sun, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/428,647

(22) Filed: Apr. 23, 2009

Related U.S. Application Data
(63) Continuation of application No. PCT/CN2008/072066, filed on Aug. 20, 2008.

(30) Foreign Application Priority Data
Aug. 21, 2007 (CN) 200710076523.4

(51) Int. Cl. G06F 15/16

(52) U.S. Cl. 709/206; 709/227

(57) ABSTRACT

A method, server and client for processing emails are disclosed. The method includes: receiving and delivering an email sent by a client; and sending a notification upon receiving a new email if determining that the received new email is a reply to the email. Through the foregoing technical solution, the user can obtain a notification in time upon arrival of a reply to a specific email, and retrieve the reply information in time.

### CROSS-REFERENCE TO RELATED APPLICATIONS

This application is a continuation of International Application No. PCT/CN2008/072066, filed on Aug. 20, 2008, which claims the benefit of Chinese Patent Application No. 200710076523.4, filed on Aug. 21, 2007, both of which are hereby incorporated by reference in their entireties.

### FIELD OF THE INVENTION

The present invention relates to the email service in the communication field, and in particular, to a method, server and client for processing emails.

### BACKGROUND OF THE INVENTION

Currently, some email services provide the function for notifying arrival of new emails. When the email box of a user receives a new email, the email system sends a short message to the user automatically, notifying arrival of the new email. The short message may also carry such information as the subject and sender of the new email. However, to avoid the trouble of receiving notifications frequently, users generally do not expect to receive the notifications of arrival of all new emails if numerous emails are received.

According to the solution in the prior art, after a user sends some emails, the user is not notified immediately upon arrival of the replies to such emails, thus being unable to retrieve the reply information in time.

### SUMMARY OF THE INVENTION

The present invention proposes a method, server and client for processing emails so that a user may receive an instant notification upon arrival of a reply to an email and retrieve the reply information in time.

The objectives can be achieved through the following technical solution:

A method for processing emails includes:

receiving an email from a client;

delivering the received email; and

notifying the sender of the email upon receiving a new email if determining that the received new email is a reply to the email.

An email sieve notification method provided in an embodiment of the present invention includes:

setting a parameter of a notification mode to a Session Initiation Protocol (SIP) Uniform Resource Identifier (URI) in a sieve script; and

sending a SIP message as a notification according to the notification mode when receiving a new email compliant with conditions of the sieve script.

An email server provided in an embodiment of the present invention includes:

a message receiving module, adapted to receive an email;

a message delivering module, adapted to send the email received by the message receiving module; and

a reply notifying module, adapted to detect a new email received by the message receiving module, and generate and send a notification if the received new email is a reply to the email.

An email client provided in an embodiment of the present invention includes:

an email delivering module, adapted to send an email out; and

a reply notification setting module, adapted to set indication information which indicates notification of reply to the email sent by the email delivering module.

The foregoing technical solution reveals that: in the embodiments of the present invention, a reply notification is set for the sent email, so that the sender of the email may receive an instant notification upon arrival of a reply to the email and retrieve the reply information in time.

### BRIEF DESCRIPTION OF THE DRAWINGS

FIG. 1 is a flowchart of processing emails according to an embodiment of the present invention.

FIG. 2 shows a structure of an email server according to an embodiment of the present invention; and

FIG. 3 shows a structure of an email client according to an embodiment of the present invention.

### DETAILED DESCRIPTION OF THE EMBODIMENTS

FIG. 1 is a flowchart of processing emails according to an embodiment of the present invention. The flowchart includes the following steps:

Block 101: The client sends an email. For example, the client may set an indication of instant notification upon arrival of a reply to the email in the sending command.

Block 102: The email server delivers the email. Generally, a Transport Control Protocol (TCP) connection may be set up between the email server of the sender and the email server of the recipient, and then the email is sent through the Simple Mail Transfer Protocol (SMTP).

Block 103: The email server sends a notification upon receiving a reply to the email. Generally, the notification is sent in a preset mode. For example, the notification may be sent in the form of a short message, which ensures timeliness, or in the form of an instant message. Multiple notification modes may be applied concurrently, and preferably, a priority is specified for each mode. For example, when sending a notification in the form of an instant message, the email server may indicate that an Instant Message Disposition Notification (IMDN) is required. If the peer fails to receive the instant message notification because the instant message service is unavailable, the notification may be sent in other modes such as short message. The user may set various available notification modes and priorities beforehand, and the notification mode of a higher priority is attempted first for sending the notification.

In the first embodiment below, the Simple Mail Transfer Protocol (SMTP) is extended to set a notification at the time of sending an email so that the notification is sent upon arrival of a reply email. The name of the extension may be defined as “Reply Mail Notification”, and the keyword corresponding to the greeting command EHLO is supposed to be “RMN”. The EHLO command is sent by the client to indicate start of an Extended SMTP (ESMTP) session. In the response to the EHLO, the server may indicate support of the ESMTP features such as Reply Mail arrival Notification (RMN) provided in an embodiment of the present invention. Moreover, in the keyword correlation parameter in the response to “EHLO” (the parameter name may be “supported-notify-method”), and the notification mode supported by the email server is specified, for example, Short Message Service (SMS), Multimedia Message Service (MMS), or Extensible Message and Presence Protocol (XMPP) instant message. If the specified notification mode is “sip”, the notification is sent through a SIP MESSAGE. A notification mode corresponds to a Uniform Resource Identifier (URI). For example, the URI corresponding to the “sip” method may be “sip:aaron@example.com”. The method and destination address of sending the RMN are specified through a Notification Mode (NM) parameter. The value of the NM parameter is a URI, for example, an SMS URI “sms:+8613010010001” which carries a telephone number, or an XMPP URI “xmpp:aaron@example.com” which carries an XMPP identifier.

In the following simple example, an email which requires notification of reply to the email is delivered through ESMTP, where the user's client (for example, user agent) sends a message to the SMTP email server through a Message Submission for Mail (MSM) port 587. Some examples of messages are given below:

<<< 220 Example.ORG SMTP server here
>>> EHLO Example.ORG
<<< 250-Example.ORG
<<< 250-RMN sms
>>> MAIL FROM:<Alice@Example.ORG> NM=sms:+8613010010001
<<< 250 <Alice@Example.ORG> sender ok
>>> RCPT TO:<Bob@Example.COM>
<<< 250 <Bob@Example.COM> recipient ok
>>> DATA
<<< 354 okay, send message
>>> (message goes here)
>>> .
<<< 250 message accepted
>>> QUIT
<<< 221 goodbye

In the foregoing examples, the messages after “<<<” are sent by the server, and the messages after “>>>” are sent by the client. The process of delivering an email includes the following steps:

Step 201: The client sends an EHLO command to start a session. The SMTP server returns the supported extension (for example, “RMN”) and its parameter “sms” which indicates support of sending an RMN through a short message. The response to the EHLO may carry many other ESMTP extensions; in this embodiment, it carries an RMN for ease of description.

Step 202: The client sends a MAIL command, which carries the sender address “FROM” and the NM parameter. The NM parameter carries an indication of notification through a short message, and a specific notification address such as “sms:+8613010010001”.

Step 203: The subsequent steps are the same as those in the conventional art. That is, the recipient address and the email content are specified through an RCPT command, and finally, the client executes a QUIT command to end the session.

Step 204: Before delivering the email, the SMTP server checks whether the email message carries a message ID header field. If the message ID header field is absent or empty, the SMTP server adds the corresponding message ID header field for the email automatically. The field is designed to match new emails and determine which email is a reply to the email.

The SMTP server delivers the email out. Upon receiving a new email of the sender, the server checks whether the “In-Reply-To” header field of the new email carries a message ID identical with the message ID of the old email which requires sending of an RMN. If the message ID is matched, the server determines the new email to be a reply to the old email, and sends a notification to the short message address specified in the reply notification mode. By default, the short message carries the subject of the old email and the relevant prompt. Supposing the subject of the old email is “Weekend Activity Plan”, the content of the notification message is exemplified below:

Your email “Weekend Activity Plan” has been answered. Please read it.

The content of the notification message may be preconfigured by the user, for example, through a web-based management interface provided by the email service. Through setting, the sending time, recipient address or summary of the old email can be carried in the message. The setting is effective on all reply email notifications. Moreover, the content of the notification message may be set for each email separately. That is, the content of the notification message may be specified through the notification content message parameter such as “NC” of the MAIL command before sending of the email, as exemplified below:

| | | |
|---|---|---|
| MAIL | FROM:<Alice@Example.ORG> | NM=sms:+8613010010001 |

NC=from:subject

In the foregoing example, the notification content is set to carry the sender address and subject. The notification content may even include the whole text of the email. For example, if the email server supports MMS, the email may be converted into an MMS message and sent to the notification address. The conversion method is detailed in RFC 4356 (Mapping Between the Multimedia Messaging Service (MMS) and Internet Mail). An example of the MAIL command is given below:

MAIL FROM:<Alice Example.ORG>NM=mms:+8613010010001 NC=full

The email server may send the corresponding short message notification to the short message gateway or short message service center, which is similar to the short message Value Added Service (VAS) in the conventional art where a short message is sent to the user. That is based on the conventional art and is not described further. Alternatively, the email server acts as an instant message client, and sends an instant message to the user's client through an instant message protocol such as XMPP, where the instant message carries the notification content and may be delivered to the client through the instant message server. Alternatively, the email server sends the email content converted into an MMS message to the multimedia message service center through an MM7 interface, and the multimedia message service center delivers the MMS message to the end user.

Alternatively, an E-Mail Notification (EMN) may be used to let the client retrieve the reply email automatically. The email server sends an EMN text to the push proxy or gateway, as exemplified below:

<xemn

mailbox=“mailat:tom@foo.com”
view=“INBOX”
event=“Reply Message”
timestamp=“2007-08-09T06:40:00Z”
sender=“John Smith &lt;john@foo.com&gt;”
datetime=“Thu, 09 Aug 2007 19:50:20 -0600”
sequence-id=“1”
uid=“136”
subject=“Re: plan for this weekend”

/>

Afterward, the push proxy or gateway sends the EMN content encoded in binary format to the client through the Push Over-The-Air (Push OTA) protocol. After resolving the content, the client may use the POP3 protocol or IMAP4 protocol automatically to request the email server for the corresponding reply email, for example, use a RETR command of the POP3 protocol, where the parameter is a unique identifier of the message, namely, the “uid” in the foregoing EMN attribute. The EMN may also include the email content directly.

Many email servers provide the function of automatic reply, and the user may set an automatic reply message for the duration of absence from the office or the duration of holidays. Generally, the content of a reply email sent automatically is independent of the original email. Therefore, the user may choose to cancel notification of the automatic reply email. Specifically, the server may check whether the reply email carries an “Auto-Submitted” header field. If such a field is carried and the value of the field is not “no”, the server determines the email to be an automatic reply email, and therefore, does not generate any notification. A notification may also be sent upon reception of an automatic reply email, but preferably, the sent notification indicates that the reply email is sent automatically. For example, the notification message is:

Your email “Weekend Activity Plan” has been answered automatically.

Besides, the automatic reply email generated by some servers does not support the header field “Auto-Submitted”, but the subject generally includes the keyword “autoreply”. Therefore, the automatic reply email may also be identified by checking whether the subject of the new email includes the keyword “autoreply”.

In the second embodiment, a Multi-purpose Internet Mail Extension (MIME) header field such as “Reply-Notification-To” is extended. The client adds the MIME header field “Reply-Notification-To” to the sent email, and the sent email also includes the notification mode and address, as exemplified below:

Reply-Notification-To: <sms:+8613010010001>

The email may include multiple addresses, for example:

Reply-Notification-To: <sms:+8613010010001>; <sms:+8613010010002>

After detecting that the email to be sent includes a reply notification header field such as “Reply-Notification-To”, the email server checks the message ID header field of the email. If this field is absent or empty, the email server sets the corresponding message ID header field for the email automatically. The email server records the relevant information, for example, the message ID and notification address of the email which requires notification of reply to the email. Subsequently, if the email server finds that the “In-Reply-To” header field of the new email matches the message ID header field of the email which requires notification of reply to the email, the email server sends a notification to the specified notification address.

Sometimes the user may receive and send emails repeatedly for the same subject, and expect to receive notifications of all the reply emails of the same subject, namely, the same email thread. In this case, the user may require notification of reply in the email thread, and specify a thread reply notification parameter “thread”, for example, set the “thread” parameter in the reply notification header field in the second embodiment:

Reply-Notification-To: <sms:+8613010010001>; thread

or set the “thread” parameter in the MAIL command in the first embodiment:

MAIL FROM:<Alice Example.ORG>NM=sms:+8613010010001 thread

Therefore, if the email server finds that the “References” header field of the new email includes the value of the message ID header field of the email which requires notification of reply to the email, the email server sends a notification to the specified notification address. In this way, the user avoids the trouble of setting a reply notification requirement separately for every email sent in an email thread.

In the third embodiment, the reply notification of the email is specified by setting a sieve notification. In this embodiment, the client may send the email first, obtain the message ID header field of the email upon completion of sending, and then generate a sieve notification script which is stored in the email server. Preferably, in this embodiment, the client itself generates the message ID header field. Otherwise, it is difficult to obtain the message ID header field generated by the server for the email. An example of a sieve script is given below:

require [“enotify”];
if header :contains “In-Reply-To” “123abc@example.org” {

notify :message “You got reply mail” “sms: +8613010010001”;

}
or:
require [“enotify”];
if header :contains “References” “*123abc@example.org*” {

notify :message “[SIEVE] ${from}: ${subject}” “sip:alice@example.com”;

}

In the foregoing sieve script, the “require [enotify]” indicates the requirement for the sieve notification capability; the subsequent “if” statement indicates that the header field includes the conditions set when the “In-Reply-To” field value is “123abc@example.org”; afterward, the “notify” action is triggered; the notification message includes the “You got reply mail” text, or includes the content of the “from” field and “subject” field of the new email, and the notification address is the short message URI address “sms:+8613010010001”. The notification message is sent if the email server finds that the new email complies with the notification conditions of the foregoing “if” statement. Besides, the “References” field may include multiple message IDs. Therefore, a wildcard “*” needs to be placed before or after the message ID.

If the notification address is a SIP URI or a SIPS URI, it is appropriate to send a notification message through a SIP MESSAGE by default. The generated notification message may be converted into the Common Presence and Instant Messaging (CPIM) format or plain text format, and then sent to the corresponding SIP URI or SIPS URI through the SIP MESSAGE. An example of the CPIM content is given below:

From: Bob <mailto:bob@example.com>
To: Alice <mailto:alice@example.com>
Subject: Help
Content-type: text/plain
Contact me.

Because the email format is similar to the CPIM format, it is very easy to perform mapping conversion. For example, both the email format and the CPIM format include the corresponding “from” and “subject” header fields. Besides, the “Content-Disposition” header field may be used to indicate that the CPIM message needs to be treated as a reply email notification. For example, the corresponding “Content-Disposition” value is “reply-mail-notification” or “sieve-notification”. In the sieve script, the content of the “message” parameter may be converted into the CPIM message body content in the plain text (text/plain) format.

More simply, a plain text (text/plain) message body may include the “message” parameter value directly such as the “from” and “subject” header field information of the email. The following is an example of the SIP MESSAGE generated by the sieve script:

notify :message “[SIEVE] ${from}: ${subject}”

“sip:alice@example.com”;

The corresponding SIP MESSAGE is:

MESSAGE sip: alice@example.com SIP/2.0
Via: SIP/2.0/TCP notifier.example.com;branch=r44F1gh345asdfd
Max-Forwards: 70
From: sip:notifier@example.com;tag=12345
To: sip:alice@example.com
Call-ID: hjk19ppd@10.10.10.6
CSeq: 1 MESSAGE
Content-Type: text/plain
<mailto:bob@example.com>; Contact me immediately!

In this way, it is appropriate if the client that receives the notification can identify the plain text (text/plain) content type, and this implementation mode is highly compatible. Alternatively, the notification message may also include the foregoing plain text content and the content in other notification formats such as CPIM. In this way, the necessary notification information can be obtained through the plain text content even if the client is unable to identify the notification content of other formats.

If the URI parameter includes a “body” parameter which specifies the content of the message body, and the sieve script contains no “message” parameter, the content in the “body” parameter of the URI is used as the message body of the SIP MESSAGE. If the “body” parameter and the “message” parameter are both contained, it is preferable to use the content of the “message” parameter and ignore the “body” parameter, or both of them are included in the finally generated notification message content. Besides, the “From” header field of the generated SIP MESSAGE is generally set to be the SIP URI address of the email server notification service rather than the address of the email sender.

General email sieve notifications may also be sent through a SIP message like the practice in this embodiment. For example, a SIP MESSAGE carrying a CPIM message body is sent as a notification. The corresponding “Content-Disposition” value may be “sieve-notification”. If the notification mode is a SIP URI or a SIPS URI, the “mode” parameter in the URI may be used to specify the SIP method. The SIP method is not limited to the SIP MESSAGE, and may be implemented through other messages such as INVITE, INFO or REFER. In the parameter, the values of some header fields of the SIP message may also be specified. Thus the flexibility of the sieve notification is greatly improved and the prevalent SIP protocol is fully used for sending notifications. As regards SIP URI or SIPS URI, see also Internet Engineering Task Force (IETF) RFC 3261. The following is an example of a “notify” sieve script that includes a SIP method:

notify :message “Contact Tom immediately!”

“sip:alice@example.com?Subject=SIEVE; method=MESSAGE”

The SIP method has more powerful functions than other modes such as SMS. For example, if an email includes multimedia contents such as voice, the SIP INVITE method may be applied so that the email server connects to the client actively. After a session is created, the email with multimedia contents is played or transmitted to the user through the Real-time Transport Protocol (RTP) or Message Session Relay Protocol (MSRP). The following is an example of the corresponding sieve script:

notify “sip: alice@example.com; method=INVITE”

The foregoing script lacks a “message” parameter. Therefore, by default, the email subject is used as the subject field of the SIP INVITE message to provide necessary information related to the email.

Besides, the Uniform Resource Locator (URL) as a hyperlink address of the email may also be included in the notification. Therefore, the user may access the reply emails in the mailbox through the hyperlink directly through the Internet Message Access Protocol (IMAP). The notification content may be carried not only in a CPIM format, but also in a sieve notification format such as “application/sieve-notification+xml”. The following is an example of the content of a notification which includes a hyperlink:

From: notifier <sip:notifier@example.com>
To: Alice <sip:alice@example.com>
Content-Type: application/sieve-notification+xml
Content-Disposition: sieve-notification
<?xml version=“1.0”?>
<sieve-notification>

<from>bob@example.org</from>
<subject>help</subject>
<message>You got reply mail</message>
<url>

imap://alice@example.com/INBOX;UIDVALIDITY=1234567/;UID=11

</url>
</sieve-notification>

In the foregoing notification, both the notification message text and the URL are included in a message body of the Extensible Markup Language (XML) format, with the Content-Type being “application/sieve-notification+xml”. The Content-Type may also be included in the messages such as a SIP INVITE message to provide necessary information of the email.

The sieve script may also specify the importance of the notification through an “importance” parameter. The parameter value “1” indicates highest importance, “2” indicates high importance, and “3” indicates low importance. The following is an example of a sieve script:

notify :importance “1”

:message “Contact Tom immediately!”
“sip:alice@example.com?Subject=SIEVE; method=MESSAGE”

If the notification is sent through a SIP method, the “Priority” header field in the SIP header field is set according to the importance of the sieve script. For example, the “importance” parameter values “1”, “2” and “3” correspond to “urgent”, “normal” and “non-urgent” values of the “Priority” field.

After sending the SIP MESSAGE, if the email server receives an error response such as a 6XX response (namely, the message is sent successfully but rejected), it is preferable not to resend the message. If the response is “513 Message Too Large”, the message needs to be shortened before it is resent. That is, the email server judges whether the message needs to be resent according to the type of the returned error. Besides, it is preferable to set an upper threshold (such as 10 times) of resending.

If the notification message is simple, a smallest EMN text may be sent to the push proxy or gateway through the email server through the Push Access Protocol (Push PAP), and the notification mode may be set to “push”. The following is an example of the sieve script:

if header :contains “In-Reply-To” “123abc@example.org” {

notify : “push: +8613010010001”;

}

The following is an example of the EMN text:

<emn

mailbox=“mailat:tom@foo.com”
timestamp=“2007-08-09T06:40:00Z”>

</emn>

Afterward, the push proxy or gateway converts the notification message into a binary format, and sends it to the client proxy through the Push Over-The-Air (Push OTA) protocol.

Through the solution based on a sieve script, the user may set the notification more flexibly. In practice, the client software just lets the user choose whether a reply notification is required, without letting the user input the sieve script. After finding that the user requires a reply notification and provides a notification address, the client generates the sieve script automatically, and uploads the sieve script to the email server through the File Transfer Protocol (FTP) or Hyper Text Transfer Protocol (HTTP) protocol.

The fourth embodiment is applicable to the Webmail scenario. Webmail is a prevalent email service provision mode. The user inputs the recipient address and the email content on the web page, and clicks the button on the web page to send an email. The user may also set some mail options, for example, whether to save sent emails. The Webmail service is easy to use, and is available from many websites.

In the embodiments of the present invention, when inputting the recipient address and email content on the web page, the user may select the option that requires notification of reply among the mail options on the web page. Therefore, after the content of the web page is delivered to the server through the HTTP protocol, the server records the message ID header field of the sent email while sending the email. Upon arrival of a new email of the user, the server sends a notification message to the preset notification address if the “In-Reply-To” header field of the new email matches the recorded message ID header field. The notification mode expected by the user and the notification address are generally fixed, and therefore, may be preset on the web page and stored in the server, without the need of being specified in the mail options separately for every email that requires notification of reply.

Besides, when the user selects the option that requires notification of reply among the mail options, the user may also specify the validity period of the notification. For example, if the validity period is set to 1 day, the server sends no notification of the reply received 1 day after the email is sent. The user may also specify whether to require notification of all reply emails in the whole email thread, or require notification of the first reply email in the email thread. The user may also specify the time segment allowed for sending a reply notification. For example, if the specified time segment is 9:00-21:00, the email server generates no reply notification beyond 9:00-21:00.

The fifth embodiment describes a scenario which requires notification of all reply emails. For example, a user who seldom uses the email service expects to be notified of reply to any sent email, but not notified of new emails actively sent by others. For that purpose, the user may set a sieve script on the email server. A simple and rough script is given below:

if exists [“In-Reply-To”] {

notify :message “You got reply mail” “sms: +8613010010001”;

}

The foregoing script means that: The email server needs to send a notification if an “In-Reply-To” header field exists. That is because existence of the “In-Reply-To” header field generally indicates a reply email. However, the original email may not necessarily be sent by this user. Although rough, the script prevents omission of any reply email, and is a practicable solution. The matching precision may be improved by adding conditions. For example, a condition that the “to” field includes the mailbox address of the user is added to the “if” conditions, thus basically ensuring that any matched new email is a reply to the user.

To implement precise reply notification, the email server records the message ID header field of the email sent by the user, and uses a test command “IsReply” in the sieve script to judge whether the new email is a reply. That is, the email server checks whether the “In-Reply-To” header field of the new email matches the recorded message ID header field according to the test command. The following is an example of the script:

if IsReply {

notify :message “You got reply mail” “sms: +8613010010001”;

}

The sixth embodiment describes how to obtain a notification message through the event subscription/notification mechanism of the SIP. After sending an email, the client obtains the message ID header field of the email, and sends a SUBSCRIBE message to the email server, with the message body carrying the corresponding sieve script, as exemplified below:

SUBSCRIBE sip:alice@mail.example.com SIP/2.0
Event: message-summary
Accept: application/sieve-notification+xml
Content-Type: application/sieve
require [“enotify”];
if header :contains “In-Reply-To” “123abc@example.org” {

notify :message “You got reply mail”;

}

For brevity, the foregoing message text omits some contents. The email server stores the sieve script, and generates a NOTIFY message once the sieve conditions are met, namely, when a reply email is received. Partial contents of an exemplary notification message are given below:

NOTIFY sip:alice@alice-phone.example.com SIP/2.0
Event: message-summary
Content-Type: application/sieve-notification+xml
<?xml version=“1.0”?>
<sieve-notifications notify-counter=“100”><notification>

<message>You got reply mail</message>

</notification></sieve-notifications>

The event package of the foregoing SUBSCRIBE message and NOTIFY message is a “message-summary”.

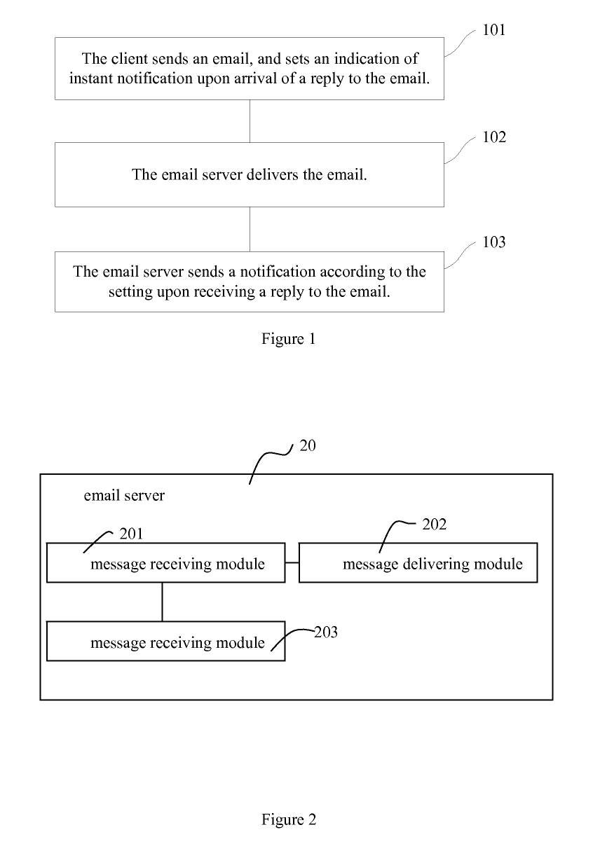

As shown in FIG. 2, an email server 20 of the present invention includes a message receiving module 201, a message delivering module 202, and a reply notification processing module 203. The message receiving module 201 receives the email; the message delivering module 202 sends the email out; and the reply notification processing module 203 generates and sends a notification after detecting that the new email received by the message receiving module 201 is a reply of which the server is required to send a notification. Specifically, as described in the first embodiment, if the reply notification processing module 203 finds that the “In-Reply-To” header field of the new email matches the message ID header field of the email which requires notification of reply to the email, the reply notification processing module 203 sends a notification to the short message address specified in the reply notification mode. The reply notification processing module 203 of the email server 20 in the sieve script solution of the present invention is adapted to send the corresponding notification after detecting that a new email received by the message receiving module 201 meets the sieve conditions. Besides, when the message delivering module 202 sends the email out, if the email requires notification of reply to the email, the message delivering module 202 checks whether the email carries a message ID. If the email carries no message ID, the message delivering module 202 generates a message ID automatically and records it.

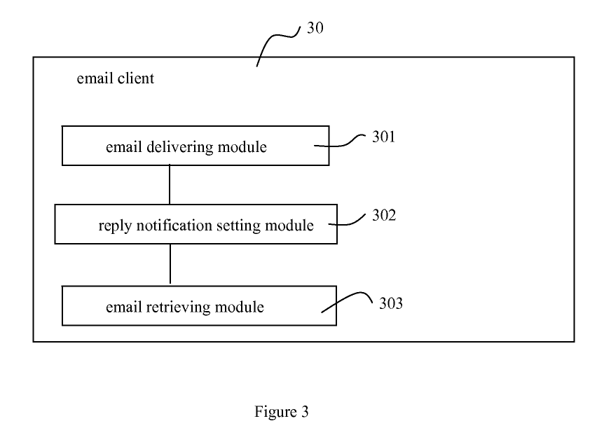

As shown in FIG. 3, an email client 30 of the present invention includes: an email delivering module 301, adapted to send the email out; and a reply notification setting module 302, adapted to set reply notification for the sent email. The reply notification setting module 302 may also generate a sieve script automatically in the third embodiment mentioned above, and upload the sieve script to the email server through a protocol such as FTP. The email client 30 may also include an email retrieving module 303. After the email client receives a reply email notification from the email server 20, the email retrieving module 303 may retrieve the reply email from the email server automatically according to the information in the reply email notification. For example, the email retrieving module 303 may retrieve new emails from the mailbox through the IMAP protocol or POP3 protocol. Specially, the email retrieving module 303 may retrieve the reply email indicated in the reply notification rather than all new emails. In this way, the user may retrieve reply emails more quickly in the case that the user uses a mobile network. Generally, the mobile network charges the user based on traffic, which saves the expense of the user and reduces the information traffic of the mobile network. Other emails may be received when the user is connected to the fixed network which charges a lower tariff. The reply notification setting module 302 sets reply notification indication information in the command of sending the email from the email delivering module 301. Alternatively, the reply notification setting module 302 uploads a sieve script carrying reply notification indication information to the email server 20.

It is understandable to those skilled in the art that all or partial steps of the foregoing embodiments can be implemented by hardware instructed by a program. The program may be stored in a computer readable storage medium. When executed, the program includes the following steps:

receiving an email from a client;

delivering the received email; and

notifying the sender of the email upon receiving a new email if determining that the received new email is a reply to the email.

The storage medium mentioned above may be a Read-Only Memory (ROM), a magnetic disk or a Compact Disk (CD).

In summary, through embodiments of the present invention, the user may receive an instant notification upon arrival of a reply to the email and retrieve the reply information in time; all or a selected part of the email contents may be notified to the user directly so that the user knows the reply email information in time; the user may set the notification method flexibly to obtain the notification conveniently, for example, select to receive notifications through short messages or instant messages; and the user may be notified of all reply emails.

It is apparent that those skilled in the art can make various modifications and variations to the present invention without departing from the spirit and scope of the present invention. The present invention is intended to cover such modifications and variations provided that they fall in the scope of protection defined by the following claims or their equivalents.

What is claimed is:

1. A method for processing emails, comprising:
receiving an email from a client;
delivering the received email; and
notifying a sender of the email upon receiving a new email if determining that the received new email is a reply to the email.

2. The method of claim 1, wherein the receiving of the email from the client comprises:
receiving and transferring an indication of instant notification upon arrival of the reply to the email while receiving the email from the client.

3. The method of claim 2, comprising: setting a reply email notification indication in parameters of a sent Simple Mail Transfer Protocol (SMTP) MAIL command, wherein the reply email notification indication carries a notification mode and address.

4. The method of claim 2, comprising:
setting the reply email notification indication in a Multi-purpose Internet Mail Extension (MIME) header field of the sent email.

5. The method of claim 1, comprising:
detecting whether the email to be delivered carries a message ID; and
adding the message ID for the email before delivery if no message ID is carried.

6. The method of claim 5, comprising:
recording the message ID of the sent email; and
sending a notification upon receiving the new email if finding that an “In-Reply-To” header field or a “References” header field of the new email carries the recorded message ID.

7. The method of claim 1, comprising:
generating a message ID for the email when the client sends the email;
receiving a sieve script which is generated by the client and requires notification of reply to the email; and
sending a notification after receiving the new email if finding that the new email meets conditions of the sieve script.

8. The method of claim 1, comprising:
by the client, selecting an option that requires notification of reply among mail options on a web page if a Webmail service is in use; and sending email contents and the mail options through a Hyper Text Transfer Protocol (HTTP);
generating and recording a message ID of the email when delivering the received email; and
sending a notification message to a preset notification address after detecting arrival of the new email if an “In-Reply-To” header field of the new email matches the recorded message ID.

9. An email sieve notification method, comprising:
setting a parameter of a notification mode to a Session Initiation Protocol (SIP) Uniform Resource Identifier (URI) in a sieve script; and
sending a SIP message as a notification according to the notification mode when receiving a new email compliant with conditions of the sieve script.

10. The method of claim 9, wherein:
the SIP message is a MESSAGE; and
the notification carries email information and is converted into a sieve notification message format or a Common Presence and Instant Messaging (CPIM) format, and is sent out through the SIP message.

11. The method of claim 9, wherein:
the SIP message is a MESSAGE, and a content type of a message body of the MESSAGE is plain text; and
email information is converted into a plain text format, and carried in the message body of the MESSAGE before being sent out.

12. The method of claim 10, wherein:
a processing mode of the notification is marked as a sieve notification; and
a client that receives the notification handles notification contents in the SIP message according to the sieve notification.

13. The method of claim 9, wherein: the sieve script carries an “Importance” parameter, and a “Priority” header field of the sent SIP message carries a corresponding value.

14. The method of claim 9, wherein: the sieve script carries a “Message” parameter, and therefore, the message body of the sent SIP message carries a value of the “Message” parameter.

15. The method of claim 9, comprising:
playing or transferring email contents to a client through a Real-time Transport Protocol (RTP) or a Message Session Relay Protocol (MSRP) after a session is created between an email server and the client through a SIP INVITE message if a SIP URI method parameter is set to “INVITE”.

16. The method of claim 9, wherein a value of a “From” header field of the SIP message is set to an address of an email server notification service.

17. An email server, comprising:
a message receiving module, adapted to receive an email;
a message delivering module, adapted to send the email received by the message receiving module; and
a reply notifying module, adapted to: detect a new email received by the message receiving module, and generate and send a notification if the received new email is a reply to the email.

18. The server of claim 17, wherein:
the message delivering module is further adapted to check whether the email carries a message ID if the message delivering module finds that the email to be sent requires notification of reply to the email, and generate a message ID for the email automatically and records the message ID as the email carries no message ID; and
the reply notification processing module is further adapted to judge whether the received new email is the reply to the email by detecting whether an “In-Reply-To” header field or “References” header field of the new email carries the recorded message ID.

19. An email client, comprising:
an email delivering module, adapted to send an email out; and
a reply notification setting module, adapted to set indication information which indicates notification of reply to the email sent by the email delivering module.

20. The client of claim 19, further comprising:
an email retrieving module, adapted to retrieve the email, and retrieve a reply email from an email server automatically according to information in a reply email notification upon receiving the reply email notification.

21. The client of claim 19, wherein:
the reply notification setting module sets reply notification indication information in a command of sending the email from the email delivering module; or
the client uploads a sieve script carrying the reply notification indication information to an email server.

22. A computer program product, comprising computer program code, which, when executed by a computer unit, will cause the computer unit to perform the steps of claim 1.
